(19) United States
(12) Patent Application Publication
(10) Pub. No.: US 2010/0062219 A1
(43) Pub. Date: Mar. 11, 2010

(54) Methods of coating a substrate with a universal primer to adhere an overlay

(76) Inventor: Scott Richards, Bayside, NY (US)

Correspondence Address: Peter S. Canelias, Suite 2620, 420 Lexington Avenue, New York, NY, 10170, US

(21) Appl. No.: 12/283,004

(22) Filed: Sep. 9, 2008

(51) Int. Cl. B05D 5/00; B05D 1/36; B32B 7/10; B32B 13/14

(52) U.S. Cl. 428/142; 427/402; 427/403; 156/298; 428/143; 156/94; 427/140; 427/207.1

(57) ABSTRACT

The invention is a method of using a waterborne acrylic latex roof membrane component as a universal primer to adhere virtually any epoxy or cementitious polymer-modified product or overlay to virtually any substrate without the need for physical preparation of the substrate surface. The present method now makes it possible to cleanly and simply adhere hundreds of coatings from various manufacturers to dozens of various substrates.

### BACKGROUND OF INVENTION

The invention is a method of using a particular waterborne acrylic latex roof coating as a universal primer for substrates, to adhere virtually any epoxy or cementitious polymer-modified product to virtually any substrate without the need for substantial physical preparation of the substrate surface. The present method now makes it possible to cleanly and simply adhere hundreds of overlay coatings from various manufacturers to dozens of various substrates.

Overlays are thin (less than one inch in height and usually less that one quarter of an inch), wet coatings that are applied to a substrate, and adhered to the substrate chemically and seamlessly without gaps or spaces. They are usually either cementitious (containing Portland cement) or resinous, such as epoxy or urethane based. Once applied to the prepared surface, i.e., the substrate, the overlay is typically allowed to cure in place.

In the overlay application field, the state of the art methods for surface preparation currently are to grind, acid etch and shot-blast concrete surfaces to ready them for adhesion to cement overlay, resurfacing, acrylic or epoxy type products. Within the art, it is considered almost impossible to have a universal primer for the preparation of a substrate, especially given the differences in substrates, including the relative porosity of the underlay surfaces. Typically, the surface of the substrate must be physically prepared for optimal adhesion of one or more top coats, often by grinding or shot blasting.

In the overlay industry, surface preparation, with the attendant noise, dust, physical effort, time, expense and discomfort, causes many in the industry to abandon the field of overlay application. For those with respiratory problems, the dust and other airborne particulate matter released into the ambient air by most conventional surface preparation methods requires at least the use of dust masks to prevent further injury. There has been a long-felt need in the overlay industry for a primer that would obviate the need for physical surface preparation. In response to this need, many attempts have been made to create such a primer, until now meeting with failure, and leading to a general skepticism within the industry that a solution to this need could be realized. The concensus in the industry has been that such a universal primer is not possible. The discovery of such a universal primer would be considered a pioneering invention in the field.

### SUMMARY OF THE INVENTION

The invention employs a known roof coating from a non-analogous field of use in a unique way as a substrate primer that uses molecular bonding to create a “universal layer” to receive and retain an overlay coating. This replaces the physical adhesion methods that have been used to date. The universal primer also now makes it possible for various coatings to adhere to almost any substrate. This is in contrast to previous coatings that could only be adhered to concrete or wood or metal. The present method of use of the universal primer can adhere coatings to tile, vinyl composition tile (VCT), linoleum, and virtually any substrate. It can be applied to horizontal and vertical surfaces, indoors and outdoors. The primer is simply applied in one thin coat by roller, brush or spray to any clean, dry and tight substrate.

The invention employs a coating that has been used in the past as a component for making waterproof roof membranes. The applicant's remarkable discovery is that a compound from an unrelated field is the key to the fulfilling the long-felt industry need for a primer that eliminates all of the substantial physical surface preparation in the overlay industry. Despite overwhelming skepticism and disbelief that the problem has indeed been solved, the applicant successfully adapted the roofing membrane component for use as a universal primer to adhere an overlay, discovering it in a field that no one in the art would have even thought to search. This product (or any other product) from the roofing industry has never been used for the flooring, coatings or overlay priming industry in any way. There are also no known products manufactured for or by the cement overlay or epoxy flooring industries that will perform the task or solve the problems which the present method solves. In sum, discovering and adapting a roofing membrane component for use in the overlay industry has produced profound and unexpected results that will revolutionize the overlay industry by substantially reducing the labor and difficulty involved.

The preferred embodiment of the universal primer, offered by Specialty Solutions Manufacturing, Inc. of New Hyde Park, N.Y. as the SeamsPerfect™ base coat, is the only product specifically used to reduce or eliminate much of the surface preparation work while offering unique waterproofing benefits for overlay contractors. The time saving aspect of the present method also enhances profitability of contractor applications.

The present method has two main embodiments (methods) of coating a substrate. The first is as a general adhesion coating, PerfectPrimer™ or the SeamsPerfect™ base coat. The second embodiment is to make a simple, walkable, flexible decorative resurfacing system, marketed under the trademark RubberDecky™. For the RubberDecky™ application, the SeamsPerfect™ base coating is combined with a pigment or tint and filler grit. The filler grit is preferably comprised of pine shavings and various grades of crushed walnut shells. The mixture is then applied in two coats, rolled directly over any substrate, such as concrete (even painted or sealed), asphalt membranes, wood, tile, roofing membranes, linoleum, VCT, or tile. It is then optionally coated with an acrylic-urethane water bourn sealer.

The present method is the fastest, easiest deck or concrete resurfacing system for pedestrian surface treatment. It can also be combined with reinforcing fabric to make the deck and waterproof system in one, where the combination of the universal primer and the fabric create a waterproof membrane. This environmentally safe system is rolled on, and is seamless, breathable, and can be tinted to any color. No special tools are required to apply the coating to any clean, dry, tight surface, indoors or outdoors. Benefits include reduced surface preparation for overlays to just two hours, eliminating the need to grind, etch or remove existing flooring or residue.

This treatment never needs to be removed or stripped, and creates an environmentally desirable “cool deck” that meets Energy Star and Prop. 65 guidelines. A deck coated by this method can be economically maintained for the life of the building with application of a clear sealer, usually about every two to three years. Thus, this method creates a virtually height-less and weightless “deck for life”, applied without odor, noise or mess.

The universal primer may also be used for crack isolation repairs; eliminating difficult crack grinding and epoxy fill methods. For this application, the universal primer is combined with a low profile mesh for fast, easy crack repairs that are compatible with any overlay. The prior method of crack repair in a concrete substrate is generally referred to as V-routing, named for the V-shaped tool used to grind open and widen an existing crack. After grinding and widening, the crack is filled with a two-part epoxy. This is an expensive and often counter-productive method of repairing cracks and fissures in a concrete substrate. The epoxy used in this method is harder than the concrete substrate, and another crack usually develops due to the inability of the concrete substrate to expand, the crack being a self-forming expansion joint. Thus, by employing the traditional method of V-routing, the tension that was relieved by the crack has been reintroduced via a harder filler epoxy, causing a crack to reappear, usually next to the repair.

### DETAILED DESCRIPTION

The applicant has discovered that a particular manufacturer, (LaPolla Industries, Inc., Houston Tex.) makes a roofing membrane (coating) that can be used as a universal primer that can adhere virtually any acrylic, urethane, epoxy or modified cement product to any typical substrate, including painted or sealed floors, glazed tile, metal, foam, cut back glue, carpet adhesive (and other glue residue) etc. The critical and defining aspect of the present claimed method is the selection and use of the roof membrane coating as a primer. As used herein, the applicant acting as his own lexicographer, the term “universal primer” as used herein and in the appended claims, refers to this particular membrane component or others with similar chemical and physical characteristics such as to allow such coating material to act as a universal primer without substantial loss of adhesion or functionality. The term “universal primer” is limited throughout this specification, including the appended claims, by the definition above.

The preferred embodiment of the universal primer, sold as the Seams Perfect™ base coat (PerfectPrimer™) forms the base adhesion layer over the substrate. This universal primer is a means for coating a substrate. The universal primer is a waterborne, acrylic latex elastomeric waterproof coating. Uses of the universal primer include virtually every decking, overlay or waterproofing situation that a user may encounter. The universal primer is a one-part, non-toxic, “green”, volatile organic component (VOC) compliant coating (which means that the product must meet the local, state or federal regulations for these products) developed to fill a multitude of needs, and simplify the user's jobs.

The method comprises the steps of applying the universal primer, preferably by roller, directly over clean cut-back glue, tile, linoleum, sealed concrete, VCT or wood, even over asphalt and roofing materials, preferably where the user wears safety glasses and chemical resistant gloves. Other substrates include step risers, curb walls and foundations. The substrate is now prepared for the second step of the process, i.e., it is ready to accept and bond any cementitious, acrylic, urethane or epoxy system. Upon application of the overlay, the substrate and overlay bond as one.

This simple yet revolutionary bonding method comprises the steps of first, if necessary, cleaning the substrate (surface) with various agents depending on the nature of the materials comprising the substrate. Such cleaning agents are well known in the art. Next, the universal primer for adhesion is applied as necessary. After priming, the next coat, typically the overlay coat is applied over the universal primer. As used herein, the terms “overlay” or “overlay coating” has the meaning generally accepted in the overlay industry, i.e., a cementitious or resinous liquified coating. Once applied to the prepared surface, i.e., the substrate, the overlay is typically allowed to cure in place atop the substrate.

The universal primer may be optionally combined with grit filler, preferably the True-Grit™ filler offered by Specialty Solutions Manufacturing, Inc. And, a sealer coat may be applied atop the overlay. Preferably, the sealer is Top Sealer™, also offered by Specialty Solutions Manufacturing, Inc., which creates a simple, inexpensive non-skid, overlay for pedestrian traffic. This liquid sealer overlay rolls or sprays on to any clean, smooth surface with little or no prep. It's ideal for patios, pools, basement floors, terraces, or rooftops where customers with a reduced budget require a waterproof or trafficable deck.

The universal primer may also be used for crack isolation repairs; eliminating difficult crack grinding and epoxy fill methods. For this application, the universal primer is combined with a low profile mesh for fast, easy crack repairs that are compatible with any overlay. The primer may even be used to repair existing concrete overlay systems for fast, low profile after-job repairs, without employing a V-routing process and incurring latent defects in the repaired area. With the flashing method described below, the crack is utilized as an expansion joint, but waterproofed and isolated from the overlay to be applied over the repaired substrate. Using this method, the repair is not “telegraphed” through the overlay, and the concrete is not tensed, allowing the substrate to move without causing de-lamination of the overlay.

Another use of the method is as a flashing system. The universal primer is combined with reinforcing fabric to create a custom flashing material that renders water-impervious all shapes, sizes, and combinations of substrates, while bonding them to one another. Similarly, the method may be used to create a waterproof underlay membrane for any overlay system. The universal primer is combined with reinforcing fabric to create a flexible, seamless waterproofing system. This is the optimal low-profile waterproof membrane and flashing system all in one, for use with an overlay system, allowing the overlay to become a waterproofing system.

Additionally, adding a second coating of the universal primer upon the overlay creates a seamless, fully adhered, energy saving “Cool-Deck”. It waterproofs, while also being resistant to mold, rot, vermin, and UV rays. It encapsulates asbestos.

The universal primer may be used instead of paint as an attractive, waterproof, wall coating to form a base coating for interior or exterior walls of masonry, wood, or block. In this application, the method creates a durable, waterproof surface with an expected life of 10-15 years before needing a re-coat, etc. It can also be tinted to match any aesthetic scheme.

Another use is for joint, crack, and low-spot filler. The universal primer is mixed, preferably on site, with filler grit to create a fast, easy, permanently flexible, exterior grade waterproof patching spackle compound. The applicant's embodiment, using the True-Grit™ filler, offered by Specialty Solutions Manufacturing, Inc. under the trademark Philly Putty™, employs a knife-grade acrylic caulk. Its creamy light texture enables application more rapidly, and provides a much more suitable filler, providing expansion and contraction, than concrete or epoxy patching methods.

The method may also be used to resurface and renew old, cracked or damaged stucco. The universal primer may be tinted as desired and applied over failed stucco and Exterior Insulation Finishing Systems (EIFS). The result leaves walls waterproof, mold resistant, aesthetically pleasing, and maintainable for years for a very low cost.

Another use is to restore and renew problematic coping stones. Use of the method maintains the original architectural aesthetics of the building. It may also be used to replace aluminum capping. The method may be used to wrap, waterproof reinforce and beautify failed, leaky or cracked coping stones, of any shape or size. This is particularly useful in reinforcing, waterproofing and repairing parapet walls, and allows a substantial cost saving by avoiding scaffolding, mess, permits, or demolition normally associated with such work.

The technical specifications for the base coating are as follows:

### Seams Perfect™ Base Coat (4274Q)

Adhesion to wood, galvanized steel, clean concrete—Excellent
Base—100% acrylic copolymer *

### Codes/approvals—Energy Star, ICC, UL, CRRC, (ASTM D6083)

SPBC-F07 meets guidelines for California Title 24 and proposition 65.
Durometer hardness—60 Shore A (ASTM D2240)

### Elongation—240% (ASTM D412)

Fire rating—Class A, ASTM E-108
Grade—spray or roll
Mold resistance—excellent
Permeance—20 U.S. Perms@ 10 mils
Reflectivity—new 85% aged 78%
Salt spray resistance—no noticeable effects
Solids by weight—67% (ASTM D1644)
Solids by volume—55%
Tear resistance—90 lbs/in (ASTM D624)
Tensile strength—275 psi (ASTM D412)
Tensile strength with fabric—3,400 psi

### Viscosity—110 K.U.

Weight per gallon—12

The shelf life of the product is typically twelve months in unopened containers (usually five gallon plastic containers) stored between 40 F°-90 F°. The universal primer should not be applied when temperatures will drop below freezing, or when precipitation is forecast.

The composition and information on ingredients of the universal primer is as follows for the preferred embodiment of the universal primer supplied by Specialty Solutions, product code 4274Q:

| Ingredient | % by weight |
|---|---|
| Acrylic Polymer | 45.0 maximum |
| Titanium Dioxide | 8.0 maximum |
| Calcium Carbonate | 35.0 maximum |
| Fused Silica | 2.0 maximum |
| Silicates/True-Grit ™ | as desired |
| Water | 10.0 maximum |
| Ammonia | 0.1 maximum |
| Residual Monomer(s) | 0.1 maximum |
| Ethylene Glycol | 1.0 maximum |

In a second embodiment of the invention, the method of the first embodiment is combined with a particular overlay to create an aesthetically pleasing textured surface. This second embodiment is referred to as RubberDecky™. This method is a simple, elegant coating system designed to resurface and/or waterproof wooden, concrete and metal surfaces while allowing for light pedestrian traffic. Unlike concrete, it flexes and moves, and never cracks and it renders the surface water impermeable while still allowing surfaces to breathe.

RubberDecky™ can be applied over virtually any clean, dry and tight surface including linoleum, VCT, tile, asphalt flat roof membranes, painted interior or exterior floors, etc. RubberDecky™ is used to renew old materials, at a fraction of the cost of traditional remove and replace methods. Requiring no special tools or masonry skills, it resurfaces without odors, noise, mess, demolition or heavy equipment. Some of the uses include: flat decks such as: those made of wood planks or plywood; concrete surfaces including pool areas, patios, pathways; metal roof decks; interior floors or concrete in wet areas, basements, sunrooms etc.

This method may also be used to create waterproof, mold resistant, crack resistant stucco over retaining walls, block buildings, or concrete foundations. In addition, it may be used on vertical surfaces such as interior sheetrock walls or over wallpaper.

The method employs the following steps to apply the overlay over any clean dry and tight wood, concrete or metal surface.

In a first step, the universal primer is mixed with filler grit, preferably True-Grit™ at a ratio of about one 16 oz cup of filler grit per gallon of primer. The user may add color tint and blend it in as desired. The user then applies one thin coat of the universal primer, preferably using a brush or ½″ rough textured roller, to the substrate. The coating is then allowed to dry. If this is a waterproofing application, the method is applied over any clean prepared or properly primed surface. If this is a waterproofing membrane application, it is preferred that a fabric is used. For non-waterproofing applications, the substrate is repaired as necessary using patching cement, preferably Philly Putty™, and a crack repair fabric.

In a second step, depending on the user's desire, more filler grit is mixed with the universal primer until the mixture “hangs” on the trowel a moment or so before dropping off. The user may apply additional color tint and blend in as required. Once the first coat is fairly dry to the touch, the second coat is applied.

In a third step, the user trowels the coating down to a thickness of about one-eighth of an inch (⅛″), ensuring that the thickness is not too much greater or it will crust and not cure properly.

A fourth step involves waiting one to two days for surface to completely dry. Then, the user may optionally apply a top sealer using a ½″ roller or micro fiber mop. The sealer should be spread as thickly as possible but ensuring that the sealer coat is even and not puddled. The user should apply second coat of sealer as soon as possible, and allow 12 hours to cure, preferably to 24 hours before allowing foot traffic.

Other optional modes of carrying out the invention include keeping the universal primer in the shade if the temperature is relatively high and keeping the lid on to avoid drying. If partially dried out, a user can add about 6-10 ounces of water and mix it in during the application process to keep the material from drying in the pail.

To achieve a marbled or blended color deck, the following techniques aid in creating these effects. After waiting until the coating dries the user then lightly sponges or rolls on some highlight color prior to sealing the surface. Another technique is, after applying the first coat, putting some tint onto the wet deck surface, and then lightly troweling it in. Another technique is, after mixing one color thoroughly into the base coat, adding some additional tint of a new color into the mix, then lightly stirring it, and then spilling it onto the deck and troweling it all in together. Of course, the sealer itself can be tinted for aesthetic effect and then applied over the surface.

In using any of the above techniques, the user should not overwork the material so as to maintain the proper appearance of color separation. A user may also experiment with different rollers, trowels and the like for different deck textures.

Since other modifications or changes will be apparent to those skilled in the art, there have been described above the principles of this invention in connection with specific apparatus, it is to be clearly understood that this description is made only by way of example and not as a limitation to the scope of the invention.

What is claimed is:

1. A method of coating a substrate to adhere an overlay coating, comprising steps of:
coating the substrate with a universal primer; and
coating the primer with the overlay coating.

2. The method of coating the substrate to adhere the overlay coating of claim 1, wherein the overlay comprises a cementitious material.

3. The method of coating the substrate to adhere the overlay coating of claim 1, wherein the substrate comprises a cementitious material.

4. The method of coating the substrate to adhere the overlay coating of claim 1, further comprising a step of coating the overlay coating with a second overlay coating.

5. The method of coating the substrate to adhere the overlay coating of claim 1, further comprising a step of embedding a reinforcing fabric in the universal primer to create a waterproofing membrane.

6. A method of coating a substrate to adhere an overlay coating, comprising steps of:
applying a means for coating the substrate to an underlay surface; and
applying the overlay coating to the means for coating the substrate.

7. A method of coating a substrate to adhere an overlay coating, comprising steps of:
mixing a universal primer with a grit filler material to create a coating mixture, and;
applying the coating mixture to the substrate to form the overlay coating.

8. The method of coating the substrate to adhere the overlay coating of claim 7, further comprising a step of applying a sealer coating to the overlay coating.

9. The method of coating the substrate to adhere the overlay coating of claim 7, further comprising a step of embedding a reinforcing fabric in the universal primer to create a waterproofing membrane.

10. The method of coating the substrate to adhere the overlay coating of claim 7, wherein the overlay coating is about one-eighth inch in thickness.

11. The method of coating the substrate to adhere the overlay coating of claim 7, wherein the mixture comprises about a 16 ounce cup of the grit filler to about one gallon of the universal primer.

12. The method of coating the substrate to adhere the overlay coating of claim 7, further comprising a step of preparing the substrate by applying a patch to a fissure in the substrate.

13. The method of coating the substrate to adhere the overlay coating of claim 7, further comprising a step of applying a waterproof fabric to the substrate.

14. The method of coating the substrate to adhere the overlay coating of claim 7, further comprising a step of applying a tint to the coating mixture.

15. The method of coating the substrate to adhere the overlay coating of claim 7, further comprising a step of applying a tint onto the overlay coating.

16. A method of coating a fissure in a substrate to adhere an overlay coating, comprising steps of:
substantially filling the fissure with a universal primer; and
coating the universal primer with the overlay coating.

17. The method of coating the fissure in the substrate to adhere the overlay coating of claim 16, further comprising a step of embedding a reinforcing fabric in the universal primer.
